(19) United States
(12) Patent Application Publication
(10) Pub. No.: US 2009/0145145 A1
(43) Pub. Date: Jun. 11, 2009

(54) AIR CONDITIONER

(75) Inventors: Hirotaka Saruwatari, Osaka (JP); Hiroyuki Matsuura, Osaka (JP); Mario Hayashi, Osaka (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/304,436

(22) PCT Filed: Jun. 7, 2007
(86) PCT No.: PCT/JP2007/061548

§ 371 Date: Dec. 11, 2008

(30) Foreign Application Priority Data
Jun. 12, 2006 (JP) 2006-162649

(51) Int. Cl. G05D 23/00; G05B 15/00

(52) U.S. Cl. 62/157; 700/276

(57) ABSTRACT

An air conditioner preferably includes a selection component (switch) and an air conditioning data acquisition/processing component (printed wiring board). Preferably, a storage component (EEPROM) records at least two sets of data of whether or not an option function is being executed and a drive condition of a compressor relating to air conditioning that the printed wiring board acquires. The switch receives display setting data indicating either one of the two sets of data. The printed wiring board includes an output port that alternatively outputs one of the data of whether or not the option function is being executed and the data of the drive condition of the compressor, and the printed wiring board performs data output processing from the output port in accordance with the display setting data that the switch has received.

### TECHNICAL FIELD

The present invention relates to an air conditioner and particularly to an air conditioner that selectively outputs information relating to the air conditioner.

### BACKGROUND ART

In a case where the status of an air conditioner is to be understood, sometimes data relating to the operating conditions of configural devices such as a compressor become necessary in order, for example, to understand information relating to the air conditioner, such as the power consumption amount and the operating time. For example, the device monitoring system described in Patent Document 1 indicated below constructs equipment that acquires various types of data and performs monitoring and control of an air conditioner on the basis of the data that are obtained.

Here, in a case where a new monitoring and control function is introduced in relation to an air conditioner, there are cases where one wishes to increase or change the types of data that are acquired in regard to the operating conditions of such configural devices. For example, in equipment that is not disposed beforehand with a function of acquiring data of the operating condition of a compressor that is disposed in an outdoor unit, there are cases where the need to acquire data of the operating condition of the compressor after construction arises.

In such a case, under present circumstances, this is handled as a result of an engineer who knows the equipment going to the site and remodeling a printed wiring board that monitors and controls the compressor. Here, the engineer performs processing on the printed wiring board, such as disposing a new output circuit for outputting data of the operating condition of the compressor outside of an output circuit for outputting data of other configural devices, for example.

<Patent Document 1>
JP2005-258557A

### DISCLOSURE OF THE INVENTION

### Problem that the Invention is to Solve

However, there are cases where such remodeling work is difficult unless one is an engineer who knows the equipment, and it is necessary for such a person to go to the trouble of going to the site and remodeling, which is troublesome.

Further, in a case where a separate output circuit is added after the fact outside of an output circuit that is disposed beforehand in the printed wiring board, there is the potential for the surface area of the printed wiring board to end up expanding. Such an expansion of the surface area of the printed wiring board also resultantly leads to an increase in the size of the finished product. Such an increase in the size of the finished product runs counter to today's needs, where making apparatus compact is desired in order to ensure installation space, which is not preferred.

The present invention has been made in view of the aforementioned points, and it is an object of the present invention to provide an air conditioner that is capable of outputting plural sets of data while controlling an increase in the size of data processing devices such as a printed wiring board.

### Means for Solving the Problem

An air conditioner pertaining to a first invention comprises an air conditioning data acquisition component, a selection component and a data processing component. The air conditioning data acquisition component acquires at least two sets of data comprising a first set of data and a second set of data relating to air conditioning. The selection component receives a selection indicating either one of the two sets of data. The data processing component includes outputting portion that alternatively outputs one of the first set of data and the second set of data, and the data processing component performs data output from the outputting portion in accordance with the selection that the selection component has received.

Here, a user can perform selection of either the first set of data or the second set of data by the selection component. Additionally, the data processing component can cause the selection of either the first set of data or the second set of data that has been received from the user via the selection component to be reflected in data output while switching and using one outputting portion.

Thus, it suffices for there to be one outputting portion, and it becomes possible to selectively output plural sets of data while controlling an increase in the size of the data processing component.

An air conditioner pertaining to a second invention comprises the air conditioner of the first invention and further comprises a nonvolatile storage component in which the selection that the selection component has received is recorded as selection data by the data processing component. Additionally, the data processing component performs the data output in accordance with the selection data.

Here, the selection data are recorded in the nonvolatile storage component, so even when the supply of power ceases, the selection data that are recorded can be held without disappearing.

Thus, even when the supply of power ceases, it becomes possible for the data processing component to continue executing data output even after power restoration, with the selection state that the user desires being maintained.

An air conditioner pertaining to a third invention comprises the air conditioner of the second invention, wherein the data processing component completes, before the data output, processing that records the most recent selection that the selection component has received in the nonvolatile storage component as selection data. Additionally, the data processing component performs data output according to the selection data that are recorded in the nonvolatile storage component at a point in time when the data processing component performs the data output.

Here, the selection data are updated to the most recent data before the data output is performed, so it becomes possible for the data processing component that performs the data output in accordance with the selection data that are recorded in the nonvolatile storage component to always perform data output according to the most recent selection data.

An air conditioner pertaining to a fourth invention comprises the air conditioner of the second invention and further comprises a power acquisition component that receives a supply of power from the outside. Additionally, the data processing component performs the data output in accordance with the selection data that are recorded in the nonvolatile storage component at a point in time when the supply of power with respect to the power acquisition component has been started.

Here, the data processing component can maintain an initial setting by performing data output according to the setting data at the point in time when the supply of power has been started.

Thus, it becomes possible to prevent inadvertent switching of the display output in the middle of operation when the supply of power is being sustained and to improve the stability of the display output.

An air conditioner pertaining to a fifth invention comprises the air conditioner of any of the first invention to the fourth invention, wherein the selection component is a switch that switches between two states. Here, as the switch, for example, a DIP switch and a button switch are also included.

Here, it becomes possible for the two states to be reflected in the switching of the selection data by a simple configuration of just switching between the two states.

An air conditioner pertaining to a sixth invention comprises an air conditioning data acquisition component, a selection storage component and a data processing component. The air conditioning data acquisition component acquires at least two sets of data comprising a first set of data and a second set of data relating to the air conditioning. The selection storage component includes selection data indicating either one of the two sets of data. The data processing component includes outputting portion that alternatively outputs one of the first set of data and the second set of data, and the data processing component performs data output from the outputting portion in accordance with the selection data. It will be noted that a case where the first set of data and the second set of data that are acquired are recorded in a nonvolatile storage component is also included.

Here, a user records beforehand the selection data of either the first set of data or the second set of data in the selection storage component. Additionally, the data processing component can cause this to be reflected in the data output while switching and using one outputting portion in accordance with the selection data of either the first set of data or the second set of data that has been received from the user and which the selection storage component includes.

Thus, it suffices for there to be one outputting portion, and it becomes possible to selectively output plural sets of data while controlling an increase in the size of the data processing component.

It will be noted that, as a subsidiary effect, a configuration that inputs data to be selected or switches the selection by a switch or the like becomes unnecessary because the selection data are recorded beforehand, so the configuration can be simplified.

An air conditioner pertaining to a seventh invention comprises the air conditioner of the sixth invention, wherein the selection storage component is nonvolatile.

Here, the selection storage component is nonvolatile, so even when the supply of power ceases, the selection data that are recorded can be held without disappearing.

Thus, even when the supply of power ceases, it becomes possible for the data processing component to continue executing data output even after power restoration, with the selection state that the user desires being maintained.

An air conditioner pertaining to an eighth invention comprises the air conditioner of any of the first invention to the seventh invention, wherein the first set of data is a set of data relating to an option function of the air conditioning. Additionally, the second set of data is a set of data relating to the driving of a compressor or an outdoor blowing fan which are different from the first option function.

Here, output of the first set of data and the second set of data are switched between, so even in a case where output of data that amounts to nothing more than the position of the option function is not obtained, it becomes possible to obtain output of data relating to the driving of the compressor or the like.

An air conditioner pertaining to a ninth invention comprises the air conditioner of any of the first invention to the seventh invention, wherein in the air conditioning, the air conditioner performs at least two operating modes comprising a normal operating mode and an energy saving operating mode. Additionally, the first set of data is a set of data relating to the operating modes. It will be noted that, here, as the energy saving operating mode, for example, there can be cited a mode that stabilizes operation and improves efficiency by performing control that sprays water on the outdoor unit by the principle of water sprinkling in a case where a high load that is equal to or greater than a predetermined value acts.

Here, in a case where the first set of data has been selected, it becomes possible to understand which operating mode of the normal operating mode and the energy saving operating mode is being executed.

An air conditioner pertaining to a tenth invention comprises the air conditioner of any of the first invention to the ninth invention, wherein the data processing component is configured by a printed wiring board.

Here, it becomes possible to output plural sets of data while controlling an increase in the size of the air conditioner by controlling an expansion of the surface area of the printed wiring board where the data processing is performed.

### EFFECTS OF THE INVENTION

In the air conditioner of the first invention, it suffices for there to be one outputting portion, and it becomes possible to selectively output plural sets of data while controlling an increase in the size of the data processing component.

In the air conditioner of the second invention, even when the supply of power ceases, it becomes possible for the data processing component to continue executing data output, with the selection state that the user desires being maintained.

In the air conditioner of the third invention, it becomes possible to always perform output according to the most recent selection data.

In the air conditioner of the fourth invention, it becomes possible to prevent inadvertent switching of the display output in the middle of operation when the supply of power is being sustained and to improve the stability of the display output.

In the air conditioner of the fifth invention, it becomes possible for the two states to be reflected in the switching of the selection data by a simple configuration of just switching between the two states.

In the air conditioner of the sixth invention, it suffices for there to be one outputting portion, and it becomes possible to selectively output plural sets of data while controlling an increase in the size of the data processing component.

In the air conditioner of the seventh invention, even when the supply of power ceases, it becomes possible for the data processing component to continue executing data output, with the selection state that the user desires being maintained.

In the air conditioner of the eighth invention, even in a case where output of data that amounts to nothing more than the position of the option function is not obtained, it becomes possible to obtain output of data relating to the driving of the compressor or the like.

In the air conditioner of the ninth invention, in a case where the first set of data has been selected, it becomes possible to understand which operating mode of the normal operating mode and the energy saving operating mode is being executed.

In the air conditioner of the tenth invention, it becomes possible to output plural sets of data while controlling an increase in the size of the air conditioner by controlling an expansion of the surface area of the printed wiring board where the data processing is performed.

### BRIEF DESCRIPTION OF THE DRAWINGS

FIG. 1 is a general block configural diagram of an air conditioner pertaining to an embodiment of the present invention.

FIG. 2 is a flowchart of data processing in the air conditioner.

FIG. 3 is a general block configural diagram of an air conditioner of modification (A).

FIG. 4 is a general block configural diagram of an air conditioner of modification (C).

FIG. 5 is a flowchart of data processing in an air conditioner of modification (D).

### DESCRIPTION OF THE REFERENCE SYMBOLS

10 Nonvolatile Storage Component (Air Conditioning Data Storage Component, Air Conditioning Data Acquisition Component, Selection Storage Component)
20 Switch (Selection Component)
30 Data Processing Component (Printed Wiring Board)
35 Output Port (Outputting Portion)
50 Power Acquisition Component
61 Compressor
62 Fan (Outdoor Blowing Fan)
100, 200, 300 Air Conditioners

### BEST MODE FOR CARRYING OUT THE INVENTION

Below, an embodiment of an air conditioner pertaining to the present invention will be described on the basis of the drawings.

### <General Configuration of Air Conditioner 100>

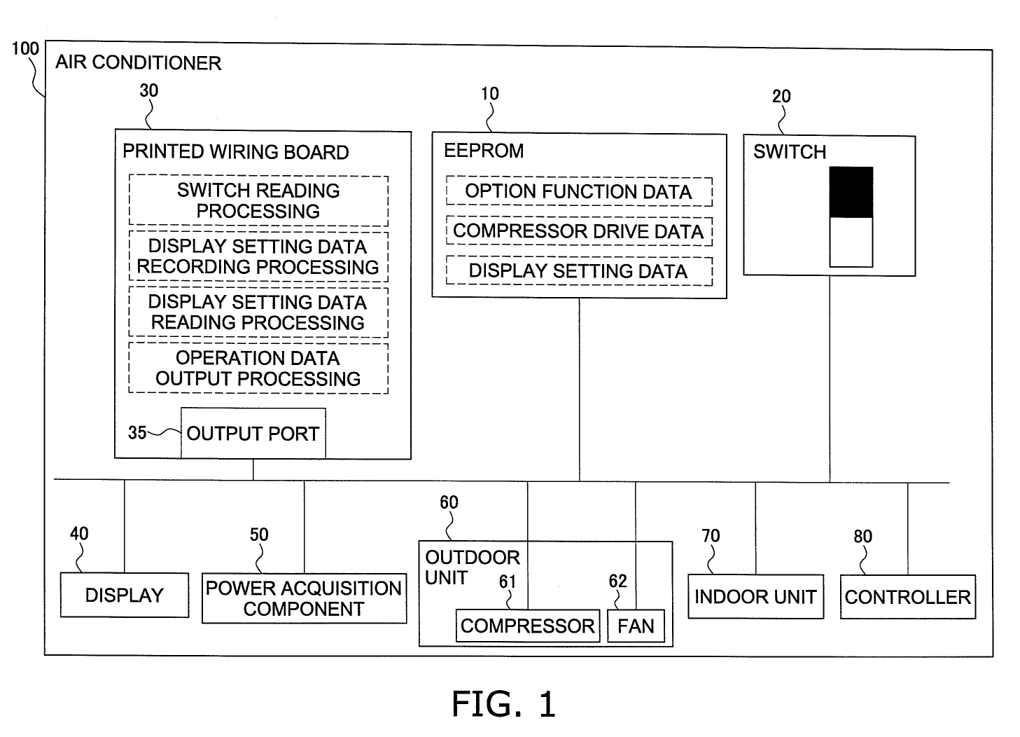

In FIG. 1, there is shown a general block configural diagram of an air conditioner 100 in which the embodiment of the present invention is employed.

The air conditioner 100 is an apparatus that conditions air of a target space and performs monitoring by displaying and outputting, while switching, plural operating conditions relating to air conditioning, and the air conditioner 100 is comprising an EEPROM 10, a switch 20, a printed wiring board 30, a display 40, a power acquisition component 50, an outdoor unit 60, an indoor unit 70 and a controller 80. In this air conditioner 100, there is employed, separately from a normal operating mode such as heating and cooling, an optional function called an energy saving operating mode that controls consumption energy during operation as an option function relating to air conditioning. The energy saving operating mode here is a mode that stabilizes operation and improves efficiency by performing control that sprays water on a heat exchanger or the like of the outdoor unit 60 by the principle of water sprinkling in a case where a high load that is equal to or greater than a predetermined value acts on the air conditioner 100.

The EEPROM 10 is connected to the printed wiring board 30, and option function data, compressor drive data and display setting data are recorded in the EEPROM 10. Of these, the option function data are data indicating whether or not the energy saving operating mode is in the middle of being executed. Further, the compressor drive data are data indicating whether or not the compressor is in the middle of being driven. The display setting data are data for identifying whether the option function data are to be displayed and outputted or whether the compressor drive data are to be displayed and outputted in a case where display and output are performed with respect to the display 40 by the printed wiring board 30. It will be noted that, because this EEPROM 10 is a nonvolatile memory, the EEPROM 10 can hold, without causing to disappear, each of the aforementioned sets of data even when operation of the air conditioner 100 stops and the supply of power ceases.

The switch 20 is connected to the printed wiring board 30 and is configured to be capable of switching between two display settings comprising a display setting that outputs the option function and a display setting that outputs the driving of a compressor 61. By operating and switching this switch 20, a user can switch the display setting between display of whether or not the energy saving operating mode that is the option function is in the middle of being executed and display of whether or not the compressor 61 is being driven.

The printed wiring board 30 is connected with respect to the switch 20, the EEPROM 10, the display 40, the outdoor unit 60, the indoor unit 70 and the controller 80, reads data from each component, and data-processes the data that have been read. Specifically, as the data processing that the printed wiring board 30 performs, there are switch reading processing, display setting data recording processing, display setting data reading processing and operation data output processing. Each of these types of data processing will be described later. It will be noted that one output port 35 is disposed in this printed wiring board 30. Output processing from the printed wiring board 30 is performed via this one output port 35.

The display 40 displays, in accordance with the data that are transmitted to the display 40 via the output port 35 of the printed wiring board 30, whether or not the energy saving operating mode that is the option function is in the middle of being executed and displays whether or not the compressor 61 is in the middle of being driven.

The power acquisition component 50 receives, from the outside, a supply of operating power for driving the EEPROM 10, the printed wiring board 30, the display 40, the outdoor unit 60, the indoor unit 70 and the controller 80 that configure the air conditioner 100. Each of the aforementioned configurations functions as a result of power being inputted from the outside with respect to this power acquisition component 50.

The outdoor unit 60 is comprising the compressor 61, a fan 62 and an unillustrated outdoor heat exchanger. The compressor 61 and the fan 62 are driven and controlled by an electrical current that flows respectively through a compressor operation circuit and a fan operation circuit (not shown). Additionally, the drive status of the compressor 61 and the drive status of the fan 62 are read by the printed wiring board 30.

The indoor unit 70 configures a refrigeration cycle together with the outdoor unit 60 as a result of interconnected by an unillustrated refrigerant communication pipe. Thus, air conditioning is performed in the space where the indoor unit 70 is disposed.

The controller 80 receives, from the user, settings of various types of operating modes such as heating and cooling by the outdoor unit 60 and the indoor unit 70, changes of the setting temperature, and settings such as ON/OFF.

### <Data Processing by Printed Wiring Board>

The printed wiring board 30 performs data processing, such as reading the data that are recorded in the EEPROM 10 and displaying and outputting various types of operating conditions to the display 40. Below, each type of processing will be described.

### (Switch Reading Processing)

The printed wiring board 30 performs switch reading processing that reads either the display setting that outputs whether or not the option function in the switch 20 is in the middle of being executed or the display setting that outputs the drive condition of the compressor 61 by performing switch reading processing. This switch reading processing is always (e.g., several times during one minute) performed by the printed wiring board 30. For this reason, even in a case where the user has operated the switch 20 and performed switching of the display setting, the printed wiring board 30 can soon recognize the switching.

### (Display Setting Data Recording Processing)

Further, in a case where the printed wiring board 30 has read the display setting from the switch 20 by the aforementioned switch reading processing, the printed wiring board 30 performs display setting data recording processing that writes this display setting in the EEPROM 10 as display setting data. It will be noted that, as mentioned above, because the printed wiring board 30 always performs the switch reading processing, the printed wiring board 30 speedily recognizes the switching of the switch 20, and reflection of the writing of the display setting data with respect to the EEPROM 10 is also speedily performed.

### (Display Setting Data Reading Processing)

Moreover, the printed wiring board 30 performs display setting data reading processing that reads the data of whether or not the energy saving operating mode that is the option function is in the middle of being executed from the operating condition of the outdoor unit 60, and the printed wiring board 30 writes the data in the EEPROM 10 as option function data. Further, in this display setting data reading processing, reading of the data of the drive condition (data relating to whether or not the compressor 61 is in the middle of being driven) from the compressor 61 of the outdoor unit 60 is also performed by the printed wiring board 30, and the printed wiring board 30 writes the data in the EEPROM 10 as compressor drive data.

### (Operation Data Output Processing)

Additionally, the printed wiring board 30 reads the display setting data that are recorded in the EEPROM 10 at a point in time when the printed wiring board 30 is about to perform data output and judges whether the display setting is the display setting of the option function data or the display setting of the compressor drive data. Here, the printed wiring board 30 performs operation data output processing that sends the data that are to be displayed on the display 40 via the output port 35 by reading the data content on the side that is set from each device of the outdoor unit 60 that is connected to the printed wiring board 30 or by reading the data (the option function data or the compressor drive data) on the side that is set from the recorded data of the EEPROM 10.

### <Flow of Data Processing>

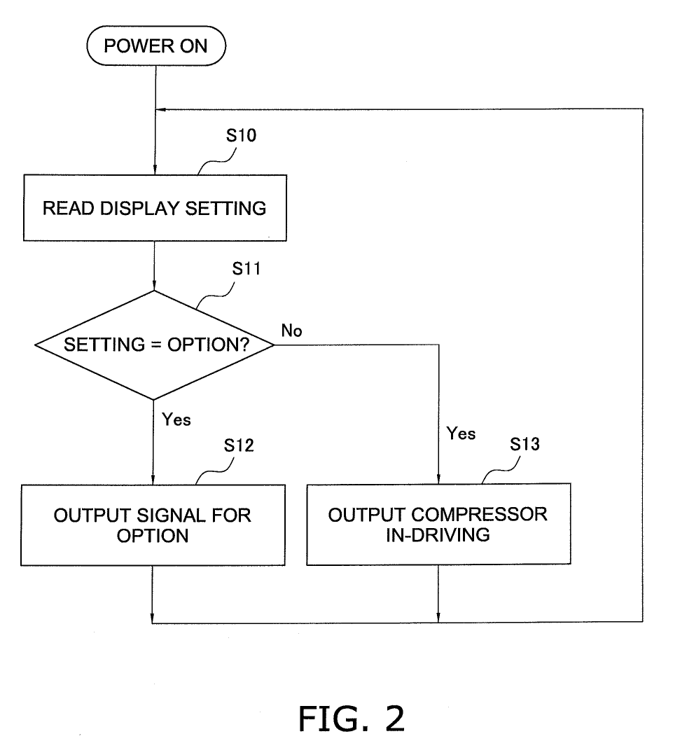

In FIG. 2, there is shown a flowchart in regard to the flow of the data processing of the switching display.

Here, a flow where the printed wiring board 30 performs output display of data with respect to the display 40 in accordance with the display setting data that are recorded in the EEPROM 10 will be described.

Processing of air conditioning data in this air conditioner 100 is started as a result of power being supplied from the outside with respect to the power acquisition component 50 (“Power On” shown in FIG. 2).

In step S10, the printed wiring board 30 first reads the display setting data that are recorded in the EEPROM 10. Then, a process with the printed wiring board 30 moves to step S11.

In step S11, the printed wiring board 30 judges whether or not the setting that has been read in the processing of step S10 is the display setting that outputs the option function. Here, in a case where the printed wiring board 30 has judged that the setting is the display setting that outputs the option function, the process with the printed wiring board 30 moves to step S12. On the other hand, in a case where the printed wiring board 30 has judged that the setting is not the display setting that outputs the option function, the process with the printed wiring board 30 moves to step S13.

In step S12, the printed wiring board 30 outputs a signal indicating the content of the option function via the output port 35 because the printed wiring board 30 has judged that the setting is the display setting that outputs the option function. Thus, image data indicating that the energy saving operating mode that is the option function is in the middle of being executed are displayed on the display 40. Then, thereafter, the process with the printed wiring board 30 again returns to step S10 and repeats the above-described processing.

In step S13, the printed wiring board 30 outputs a signal indicating the drive status of the compressor 61 via the output port 35 because the printed wiring board 30 has judged that the setting is not the display setting that outputs the option function. Thus, image data indicating whether or not the compressor 61 is being driven are displayed on the display 40. Then, thereafter, the process with the printed wiring board 30 again returns to step S10 and repeats the above-described processing.

It will be noted that, here, each time that the printed wiring board 30 performs the operation data output processing, the printed wiring board 30 reads the display setting data that are recorded in the EEPROM 10. For this reason, in a case where the display setting of the switch 20 has been switched by the user after the display output of the option function of step S12 or the display output of the compressor 61 of step S13 has been performed, the printed wiring board 30 speedily causes this to be reflected in the display setting data of the EEPROM 10, and beginning with the next display output, the display setting after being switched is read by the printed wiring board 30 and the operation data output processing is performed on the basis of the display setting after being switched.

### <Characteristics of Air Conditioner of Present Embodiment>

(1)

In the air conditioner 100 of the present embodiment, the output display in regard to the option function and output display relating to the drive condition of the compressor 61 are alternatively outputted from the one output port 35 simply by the user switching the display setting of the switch 20. Thus, in a case where the printed wiring board 30 tries to cause the display 40 to display both the output display in regard to the option function and the output display relating to the drive condition of the compressor 61, an enlargement of the surface area of the printed wiring board 30 can be controlled without having another output port in the printed wiring board 30. Thus, an increase in the size of the apparatus in which the printed wiring board 30 is housed can be controlled.

Further, even in a case where the data of the execution condition of the energy saving operating mode that serves as the option function are unnecessary, the display output of the data of the drive condition of the compressor 61 or the like can be obtained by effectively utilizing the output port 35.

It will be noted that, as mentioned above, by obtaining the data relating to the drive condition of the compressor 61, the data can be utilized to monitor the operating time of air conditioning or to understand the power consumption amount. That is, in a case where one wishes to utilize the data of the operating condition of the compressor 61 to monitor the operating time or to calculate data of the power consumption amount, it suffices simply for the user to switch the display setting of the switch 20.

(2)

In the air conditioner 100 of the present embodiment, the medium in which the display setting data are recorded is the nonvolatile memory EEPROM 10, so even when the power supply state ceases because of a stop in operation or the like, the display setting data are held as recorded in the EEPROM 10 without disappearing. Thus, even in a case where operation is resumed after power restoration, the operation data output processing according to the content that the user has set during previous operation can be automatically executed.

(3)

In the air conditioner 100 of the present embodiment, the printed wiring board 30 reads and verifies the display setting data that are recorded in the EEPROM 10 each time that the printed wiring board 30 performs the operation data output processing. For this reason, in a case where the display setting of the switch 20 has been switched by the user, the printed wiring board 30 can speedily cause the switching to be reflected and perform the operation data output processing according to the display setting after the switching.

### <Modifications of Present Embodiment>

### (A)

In the air conditioner 100 of the preceding embodiment, there has been described, by way of example, a case where the printed wiring board 30 displays and outputs in accordance with the display setting data that are recorded in this EEPROM 10.

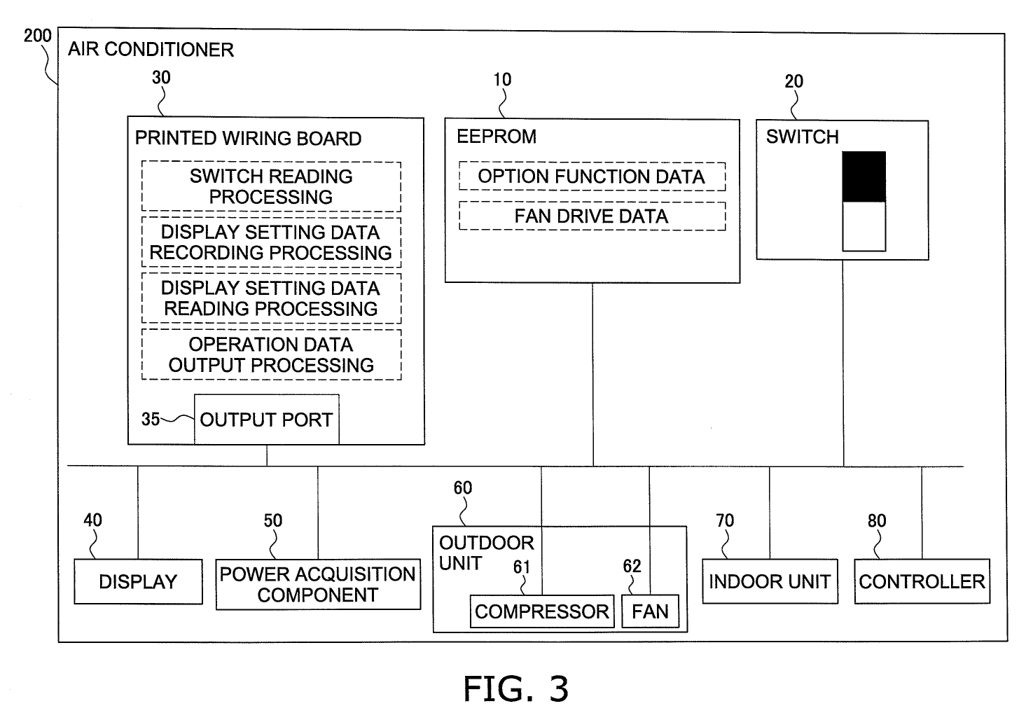

However, the present invention is not limited to this; for example, the invention may also be given a configuration where the display setting data recording processing is not performed by the printed wiring board 30 with respect to the EEPROM 10 as in an air conditioner 200 shown in FIG. 3. In this case, the printed wiring board 30 may be configured to understand the switching state of the switch 20 and select the output data in accordance with this switching state each time that the printed wiring board 30 performs the operation data output processing.

### (B)

Further, in the air conditioner 100 of the preceding embodiment, there has been described, by way of example, a case where the invention deems operating condition data of the compressor 61 of the outdoor unit 60 necessary and alternatively displays and outputs the option function data and the compressor drive data.

However, the present invention is not limited to this; the invention may also be configured to deem operating condition data of the fan 62 of the outdoor unit 61 necessary and alternatively display and output the option function data and fan drive data as in the air conditioner 200 shown in FIG. 3.

Further, the air conditioner 200 may also, for example, be configured to display and output the operating mode of the air conditioner 200 rather than the compressor drive data or the fan drive data in a case where air conditioning is being performed by either the normal operating mode or the energy saving operating mode. Thus, the operating mode that the air conditioner 200 is executing can be understood.

### (C)

In the air conditioner 100 of the preceding embodiment, there has been described, by way of example, a case where the printed wiring board 30 reads, and stores in the EEPROM 10, the display setting data by switching by the switch 20.

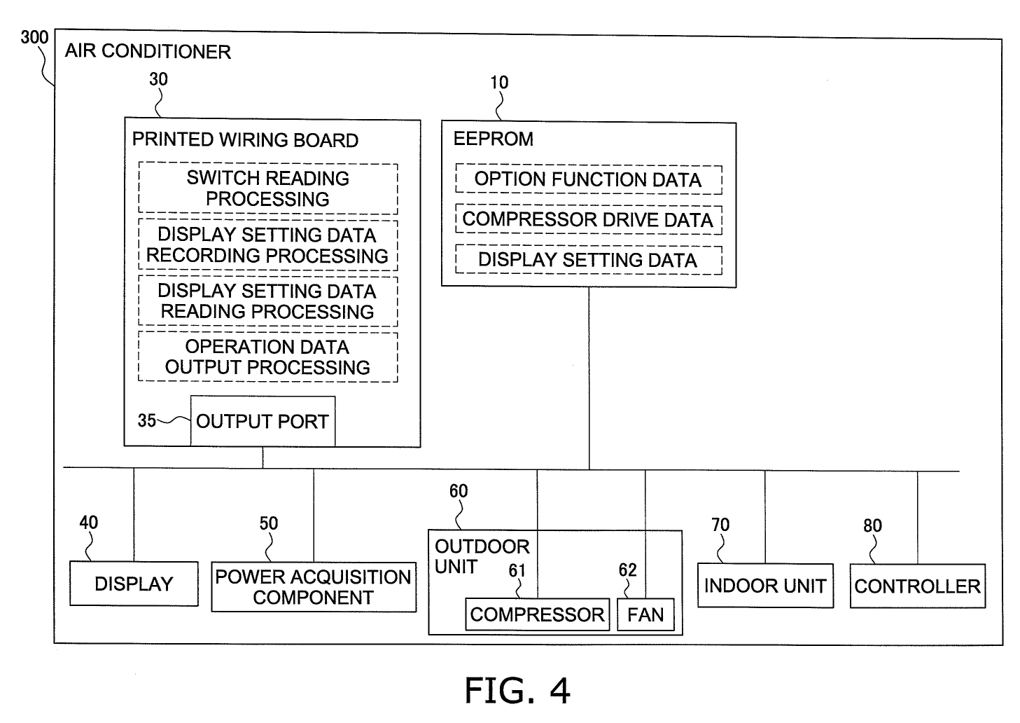

However, the present invention is not limited to this; for example, the invention may also be configured such that the switch 20 is not disposed and such that the display setting data are recorded beforehand in the EEPROM 10 as in an air conditioner 300 shown in FIG. 4. In this case, the printed wiring board 30 may be configured to select, and display and output, either the option function data or the compressor drive data in accordance with the display setting data that are recorded in this EEPROM 10.

For this reason, the output display in regard to the option function and the output display relating to the drive condition of the compressor 61 can be alternatively outputted from the one output port 35 simply by the user changing the display setting data that are recorded beforehand in the EEPROM 10. Thus, the printed wiring board 30 can cause the display 40 to display both the output display in regard to the option function and the output display relating to the drive condition of the compressor 61 without having another output port to be disposed in the printed wiring board 30.

Further, even in a case where the data relating to the energy saving operating mode that serves as the option function are unnecessary, the display output of the data relating to the compressor 61 or the like can be obtained by effectively utilizing the output port 35.

It will be noted that, as mentioned above, by obtaining the data relating to the drive condition of the compressor 61, the data can be utilized to monitor the operating time of air conditioning or to understand the power consumption amount. That is, when one wishes to utilize the data of the operating condition of the compressor 61 to monitor the operating time or to calculate data of the power consumption amount, it suffices simply for the user to select the display setting data that are recorded beforehand in the EEPROM 10.

### (D)

In the air conditioner 100 of the preceding embodiment, there has been described, by way of example, a case where the printed wiring board 30 reads, and stores in the EEPROM 10, the display setting data by switching by the switch 20 and displays and outputs the display setting data in accordance with the display setting data that are recorded in this EEPROM 10.

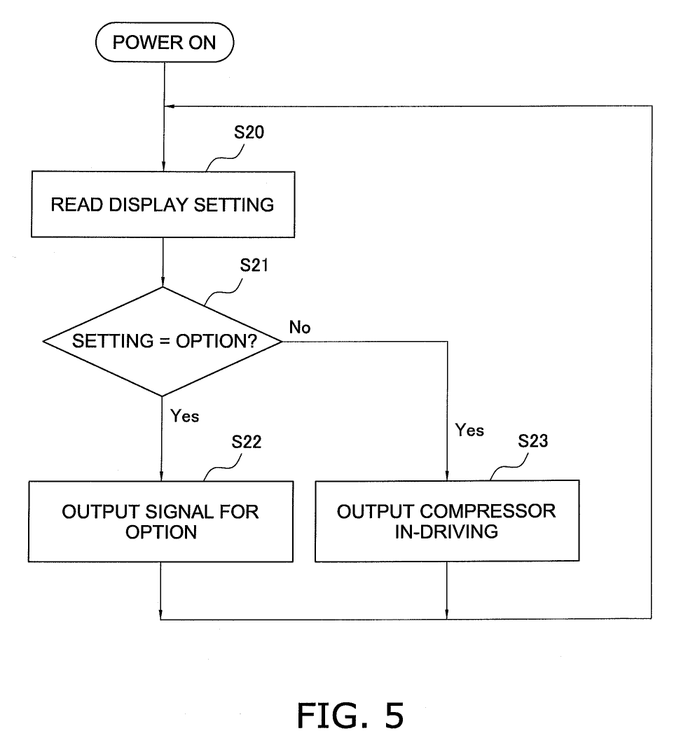

However, the present invention is not limited to this; for example, the invention may also be configured such that the printed wiring board 30 reads the display setting data that are recorded in the EEPROM 10 at a point in time when power is supplied with respect to the power acquisition component 50 as shown in the flowchart of FIG. 5. After this, when the supply of power ceases, the display setting data that the printed wiring board 30 is recognizing can be maintained until the supply is again started.

The flow of data processing here is specifically as follows. It will be noted that the point that the processing of the air conditioning data starts by the start of the power supply from the outside with respect to the power acquisition component 50 (“Power On” in FIG. 5) is the same as in the preceding embodiment.

In step S20, the printed wiring board 30 first reads the display setting data that are recorded in the EEPROM 10. Then, the printed wiring board 30 moves to step S21.

In step S21, the printed wiring board 30 judges whether or not the setting that has been read in the processing of step S20 is the display setting that outputs the option function. Here, in a case where the printed wiring board 30 has judged that the setting is the display setting that outputs the option function, the printed wiring board 30 moves to step S22. On the other hand, in a case where the printed wiring board 30 has judged that the setting is not the display setting that outputs the option function, the printed wiring board 30 moves to step S23.

In step S22, the printed wiring board 30 outputs a signal indicating the content of the option function via the output port 35 because the printed wiring board 30 has judged that the setting is the display setting that outputs the option function. Thus, image data indicating that the energy saving operating mode that is the option function is in the middle of being executed are displayed on the display 40. Then, thereafter, the printed wiring board 30 again returns to step S21 and repeats the above-described processing.

In step S23, the printed wiring board 30 outputs a signal indicating the drive status of the compressor 61 via the output port 35 because the printed wiring board 30 has judged that the setting is not the display setting that outputs the option function. Thus, image data indicating whether or not the compressor 61 is being driven are displayed on the display 40. Then, thereafter, the printed wiring board 30 again returns to step S22 and repeats the above-described processing.

Additionally, here, the display setting data reading processing (S20) of the display setting data of the EEPROM 10 by the printed wiring board 30 is performed only one time at the time when the power is switched ON, so in contrast to the preceding embodiment, the printed wiring board 30 does not perform the display setting data reading processing each time that the printed wiring board 30 performs the operation data output processing. That is, the printed wiring board 30 continues executing the operation data output processing according to the display setting data that are recorded in the EEPROM 10 at the time when the power is switched ON, and until power is cut off, even when switching of the switch 20 has been performed by the user, for example, the data that are displayed and outputted do not change. Thus, inadvertent switching of the display output in the middle of operation can be prevented, and the stability of the display output can be improved.

### INDUSTRIAL APPLICABILITY

By utilizing the present invention, plural sets of data can be alternatively outputted without being accompanied by an expansion of the surface area of a printed wiring board and an increase in the size of an apparatus, so the present invention can be applied particularly to an air conditioner that selectively handles plural types of data relating to air conditioning.

1. An air conditioner comprising:
an air conditioning data acquisition component configured to acquire at least two sets of data including a first and second sets of data relating to air conditioning;
a selection component configured to receive a selection indicating either one of the first and second sets of data; and
a data processing component including an outputting portion configured to alternatively output one of the first and second sets of data, with the data processing component being configured to perform data output from the outputting portion in accordance with the selection received by the selection component.

2. The air conditioner of claim 1, further comprising
a nonvolatile storage component configured to store the selection received by the selection component as selection data recorded by the data processing component, wherein
the data processing component is configured to perform the data output in accordance with the selection data.

3. The air conditioner of claim 2, wherein
the data processing component is further configured to complete, before the data output, processing that records the most recent selection received by the selection component in the nonvolatile storage component as selection data and performs data output according to the selection data that are recorded in the nonvolatile storage component at a time when the data processing component performs the data output.

4. The air conditioner of claim 2, further comprising
a power acquisition component configured to receive a supply of power from outside the air conditioned, wherein
the data processing component performs the data output in accordance with the selection data that are recorded in the nonvolatile storage component at a point in time when the supply of power with respect to the power acquisition component has been started.

5. The air conditioner of claim 1, wherein
the selection component is a switch that switches between two states.

6. An air conditioner comprising:
an air conditioning data acquisition component configured to acquire at least two sets of data including first and second sets of data relating to the air conditioning;
a selection storage component configured to store selection data indicating either one of the first and second sets of data; and
a data processing component including an outputting portion configured to alternatively output one of the first and second sets of data, with the data processing component being configured to perform data output from the outputting portion in accordance with the selection data.

7. The air conditioner of claim 6, wherein
the selection storage component is nonvolatile.

8. The air conditioner of claim 6, wherein
the first set of data is a set of data relating to an option function of the air conditioning, and
the second set of data is a set of data relating to the driving of a compressor or an outdoor blowing fan which are different from the option function.

9. The air conditioner of claim 6, wherein
the air conditioner is configured to perform at least two operating modes including a normal operating mode and an energy saving operating mode, and
the first set of data is a set of data relating to the operating modes.

10. The air conditioner of claim 6, wherein
the data processing component is a printed wiring board.

11. The air conditioner of claim 8, wherein
the air conditioner is configured to perform at least two operating modes including a normal operating mode and an energy saving operating mode, and
the first set of data is a set of data relating to the operating modes.

12. The air conditioner of claim 11, wherein
the data processing component is a printed wiring board.

13. The air conditioner of claim 2, wherein
the selection component is a switch that switches between two states.

14. The air conditioner of claim 3, wherein
the selection component is a switch that switches between two states.

15. The air conditioner of claim 4, wherein
the selection component is a switch that switches between two states.

16. The air conditioner of claim 1, wherein
the first set of data is a set of data relating to an option function of the air conditioning, and
the second set of data is a set of data relating to driving of a compressor or an outdoor blowing fan which are different from the option function.

17. The air conditioner of claim 1, wherein
the air conditioner is configured to perform at least two operating modes including a normal operating mode and an energy saving operating mode, and
the first set of data is a set of data relating to the operating modes.

18. The air conditioner of claim 1, wherein
the data processing component is a printed wiring board.

19. The air conditioner of claim 16, wherein
the air conditioner is configured to perform at least two operating modes including a normal operating mode and an energy saving operating mode, and
the first set of data is a set of data relating to the operating modes.

20. The air conditioner of claim 19, wherein
the data processing component is a printed wiring board.
